(19) United States
(12) Patent Application Publication
(10) Pub. No.: US 2008/0206842 A1
(43) Pub. Date: Aug. 28, 2008

(54) Method of Conversion of Biodegradable Hygienically Non-Stabilized Substrate Into Hygienically Stabilized Product

(76) Inventors: Vaclav Holusa, Dolni Lhota (CZ); David Sindelar, Ostrava-Poruba (CZ); Petr Vanicek, Psg (CZ)

Correspondence Address: Oppedahl Patent Law Firm LLC, P.O. BOX 4850, FRISCO, CO, 80443-4850, US

(21) Appl. No.: 12/090,479

(22) PCT Filed: Nov. 16, 2005
(86) PCT No.: PCT/CZ2005/000087

§ 371 Date: Apr. 16, 2008

(51) Int. Cl. C02F 3/34

(52) U.S. Cl. 435/262

(57) ABSTRACT

The pack, made of biodegradable, hygienically non-stabilized, i.e. potentially unhealthy substrate, is placed into a space separated from the surrounding atmosphere and put through aerobic fermentation involving the step of exposing the whole volume of the pack at the same time to the temperature of 70°-80° C. for 30-60 min. With an advantage, the temperature of the pack is controlled during the fermentation by the amount of externally supplied air and by intensity of restacking of the pack. The product of the aerobic fermentation is hygienically stabilized, i.e. unobjectionable product, suitable for further processing without the necessity of any special hygienic means such-as composting or processing into fuel.

### TECHNICAL FIELD

The invention concerns the method of biological waste processing, mainly waste which is able to contaminate environment, smell producing waste and hygienically faulty waste, and it solves hygiene security for the next manipulation with such waste. Hygienically stabilized substrate can be subsequently processed avoiding the danger of environmental damage, e.g. by composting or used as fuel.

### DESCRIPTION OF PRIOR ART

It is known that waste of biological origin is stored in dumping grounds. The disadvantage of dumping is its growing demand for space while the dumping grounds operation rules are getting stricter. It is also, known that waste of biological origin is composted without further adjustment. The disadvantage of composting without previous adjustment is that the processed material becomes hygienically unobjectionable only after a few months. The disadvantage of storing as well as composting is that biological waste in dumping and composting grounds usually represent increased danger, first of all contamination of subsoil water, leaking smell or, thanks to its conditional pathogenity, it is a potential source of infection. It is also known that biological waste can be burnt whereas high volume of water in the burnt material is unwanted because the heating power is reduced with the growing volume of water. With high volume of water the fuel becomes nonflammable. Further on, it is known that biological waste can be aerobically fermented. CZ patent 286614 concerns a method of processing of treatment-plant-sludge mixture and solid biowaste, e.g. wooden chips, sawdust or separated municipal biowaste. The given mixture making the pack undergoes 2-4 day aerobic fermentation after which it is dried to the dry mass volume of 70-90% and afterwards it is granulated or made into briquettes. The process produces fuel. The disadvantage of this method is that turning the whole volume of the dumping ground into hygienic one is not secured as this process is not done in a closed environment, insulated from the surrounding so there is a heat leaking. This is shown by the lower temperature near the surface of the pack where the fermentation process does not run intensively enough and therefore, the total time of processing is longer. The next disadvantage is spreading of pathogenic organisms along with evaporating water, aerosols and solid elements when manipulating with the pack. Another disadvantage is the energetic demand of the process as there is the necessity of a heat source for the substrate drying.

### DISCLOSURE OF INVENTION

The mentioned disadvantages are solved by the method of conversion of biodegradable hygienically unstable substrate into hygienically stabilized product according to the invention whose principal is to place the pack into a space separated from the surrounding atmosphere after which it undergoes an aerobic fermentation. The aerobic fermentation involves the step of exposing the pack to the temperature of 70°-80° C. for 30-60 min, the whole volume at the same time. Another alternative is to control the temperature of the pack during the fermentation by the volume of externally brought air and intensity of pack restacking.

The advantage of the method according to the invention is changing of the biowaste into a raw material which is not biologically active, does not pollute the environment and is not a source of disturbing smell. Another advantage is the short processing time. The facility realizing the method need not be inadequately large, even with high production capacity. An advantage is also low energetic demand as for the run of the process, there is no need of an external heat source.

### EXAMPLES OF IMPLEMENTATIONS OF THE INVENTION

### Example 1

A pack containing aerobic micro-organisms, consisting of a mixture of cereal straw, chips and sludge from the municipal sewerage plant in 1:1:1 volume rate is placed into enclosed heat-insulated fermentation reactor which is equipped with air-supply and exhaust of evolving gases.

The maximum size of inseparable elements in a pack is 50 mm. The temperature of the pack increases by the process of aerobic fermentation, so that the temperature in the fermentation reactor reaches 40°-50° C. after 8 hrs. In this phase, water steam is exhausted from the reactor. The fermentation itself is done while restacking the pack and controlling the amount of externally supplied air at this range of temperature for 36 hours. Intensity of fermentation is controlled by the volume of external brought air on the basis of temperature measuring and detecting of CO₂ in the evolving gases. Afterwards the amount of the externally supplied air is lowered, so the temperature gradually rises for 24 hours until it reaches the range of 70°-80° C. The pack is kept at this range of temperature for 35 minutes. The next phase is an intensive ventilation which is done until the maximum 10% volume of humidity is reached.

### Example 2

The difference between the example 2 and 1 is that the pack consists of 40% of sludge from textile industry and 60% of rape straw.

### Example 3

The difference between the example 3 and 1 is that the pack consists of 35% of paper production sludge and pulp, 15% of wooden shavings and saw dust, 20% of green chips and 30% of rape straw.

### Example 4

The difference between the example 4 and 1 is that the pack consists of 15% of starch processing sludge, 25% of rape straw, 25% of wooden shavings and saw dust, 25% of green chips and 10% of pine bark.

### Example 5

The difference between the example 5 and 1 is that the pack consists of 50% of municipal sewerage plant sludge, 25% of non-standard waste paper and 25% of rape straw.

Kitchen waste, energetic sorrel straw, shattered municipal waste, food industry waste or plastic substrate can be used for the pack.

All the mentioned % concern volumes.

### TECHNICAL FIELD

The invention concerns the method of biological waste processing, mainly waste which is able to contaminate environment, smell producing waste and hygienically faulty waste, and it solves hygiene security for the next manipulation with such waste. Hygienically stabilized substrate can be subsequently processed avoiding the danger of environmental damage, e.g. by composting or used as fuel.

### DESCRIPTION OF PRIOR ART

It is known that waste of biological origin is stored in dumping grounds. The disadvantage of dumping is its growing demand for space while the dumping grounds operation rules are getting stricter. It is also, known that waste of biological origin is composted without further adjustment. The disadvantage of composting without previous adjustment is that the processed material becomes hygienically unobjectionable only after a few months. The disadvantage of storing as well as composting is that biological waste in dumping and composting grounds usually represent increased danger, first of all contamination of subsoil water, leaking smell or, thanks to its conditional pathogenity, it is a potential source of infection. It is also known that biological waste can be burnt whereas high volume of water in the burnt material is unwanted because the heating power is reduced with the growing volume of water. With high volume of water the fuel becomes nonflammable. Further on, it is known that biological waste can be aerobically fermented. CZ patent 286614 concerns a method of processing of treatment-plant-sludge mixture and solid biowaste, e.g. wooden chips, sawdust or separated municipal biowaste. The given mixture making the pack undergoes 2-4 day aerobic fermentation after which it is dried to the dry mass volume of 70-90% and afterwards it is granulated or made into briquettes. The process produces fuel. The disadvantage of this method is that turning the whole volume of the dumping ground into hygienic one is not secured as this process is not done in a closed environment, insulated from the surrounding so there is a heat leaking. This is shown by the lower temperature near the surface of the pack where the fermentation process does not run intensively enough and therefore, the total time of processing is longer. The next disadvantage is spreading of pathogenic organisms along with evaporating water, aerosols and solid elements when manipulating with the pack. Another disadvantage is the energetic demand of the process as there is the necessity of a heat source for the substrate drying.

### DISCLOSURE OF INVENTION

The mentioned disadvantages are solved by the method of conversion of biodegradable hygienically unstable substrate into hygienically stabilized product according to the invention whose principal is to place the pack into a space separated from the surrounding atmosphere after which it undergoes an aerobic fermentation. The aerobic fermentation involves the step of exposing the pack to the temperature of 70°-80° C. for 30-60 min, the whole volume at the same time. Another alternative is to control the temperature of the pack during the fermentation by the volume of externally brought air and intensity of pack restacking.

The advantage of the method according to the invention is changing of the biowaste into a raw material which is not biologically active, does not pollute the environment and is not a source of disturbing smell. Another advantage is the short processing time. The facility realizing the method need not be inadequately large, even with high production capacity. An advantage is also low energetic demand as for the run of the process, there is no need of an external heat source.

### EXAMPLES OF IMPLEMENTATIONS OF THE INVENTION

### Example 1

A pack containing aerobic micro-organisms, consisting of a mixture of cereal straw, chips and sludge from the municipal sewerage plant in 1:1:1 volume rate is placed into enclosed heat-insulated fermentation reactor which is equipped with air-supply and exhaust of evolving gases.

The maximum size of inseparable elements in a pack is 50 mm. The temperature of the pack increases by the process of aerobic fermentation, so that the temperature in the fermentation reactor reaches 40°-50° C. after 8 hrs. In this phase, water steam is exhausted from the reactor. The fermentation itself is done while restacking the pack and controlling the amount of externally supplied air at this range of temperature for 36 hours. Intensity of fermentation is controlled by the volume of external brought air on the basis of temperature measuring and detecting of CO₂ in the evolving gases. Afterwards the amount of the externally supplied air is lowered, so the temperature gradually rises for 24 hours until it reaches the range of 70°-80° C. The pack is kept at this range of temperature for 35 minutes. The next phase is an intensive ventilation which is done until the maximum 10% volume of humidity is reached.

### Example 2

The difference between the example 2 and 1 is that the pack consists of 40% of sludge from textile industry and 60% of rape straw.

### Example 3

The difference between the example 3 and 1 is that the pack consists of 35% of paper production sludge and pulp, 15% of wooden shavings and saw dust, 20% of green chips and 30% of rape straw.

### Example 4

The difference between the example 4 and 1 is that the pack consists of 15% of starch processing sludge, 25% of rape straw, 25% of wooden shavings and saw dust, 25% of green chips and 10% of pine bark.

### Example 5

The difference between the example 5 and 1 is that the pack consists of 50% of municipal sewerage plant sludge, 25% of non-standard waste paper and 25% of rape straw.

Kitchen waste, energetic sorrel straw, shattered municipal waste, food industry waste or plastic substrate can be used for the pack.

All the mentioned % concern volumes.

1. Method of conversion of biodegradable hygienically non-stabilized substrate into hygienically stabilized product, where the pack of the said substrate is placed into a space separated from the surrounding atmosphere and then the pack is put through aerobic fermentation conditioned by externally supplied air, where the aerobic fermentation involves the step of exposing the pack to the temperature of 70°-80° C., characterized in that the step of exposing the pack to the temperature of 70°-80° C. proceeds in the whole volume of the pack at the same time and takes 30-60 minutes, in the process the pack is restacking during the aerobic fermentation.

2. Method according to claim 1 characterized in that the temperature of the pack is controlled during the fermentation by the amount of externally supplied air and by the intensity of restacking of the pack.
